(19) United States
(12) Patent Application Publication
(10) Pub. No.: US 2026/0010832 A1
(43) Pub. Date: Jan. 8, 2026

(54) METHOD, APPARATUS, DEVICE AND STORAGE MEDIUM OF PROCESSING INFORMATION

(71) Applicants: Beijing Zitiao Network Technology Co., Ltd., Beijing (CN); Lemon Inc., Grand Cayman (KY)

(72) Inventors: Xun Guo, Beijing (CN); Haibin Huang, Los Angeles, CA (US); Chongyang Ma, Los Angeles, CA (US)

(21) Appl. No.: 19/258,425

(22) Filed: Jul. 2, 2025

(30) Foreign Application Priority Data
Jul. 2, 2024 (CN) 202410883719.8

(51) Int. Cl. G06N 20/00; G06F 18/22; G06F 18/241

(52) U.S. Cl. CPC G06N 20/00; G06F 18/22; G06F 18/241

(57) ABSTRACT

The embodiment of the disclosure relates to a method, apparatus, device and a computer readable storage medium of processing information. The method proposed herein includes: obtaining target content to be processed; determining a target encoding representation of the target content with an encoding model; and determining a target generation manner of the target content based on a comparison between the target encoding representation and a plurality of predetermined encoding representations, the plurality of predetermined encoding representations corresponding to a plurality of predetermined generation manners, the plurality of predetermined generation manners including a plurality of model generation manners, the plurality of predetermined encoding representations being determined by processing a plurality of groups of sample contents with the encoding model, each group of sample contents corresponding to a respective predetermined generation manner.

### CROSS REFERENCE

This disclosure claims priority to Chinese Patent Application No. 202410883719.8, filed on Jul. 2, 2024 in the Chinese Intellectual Property Office and entitled “METHOD, APPARATUS, DEVICE AND STORAGE MEDIUM OF PROCESSING INFORMATION”, the disclosure of which is incorporated by reference herein in its entirety.

### FIELD

Example embodiments of the present disclosure generally relate to the field of computers, and in particular, to a method, apparatus, device and computer readable storage medium of processing information.

### BACKGROUND

In recent years, artificial intelligence technology has developed rapidly, and various models are applied to generate various contents. Content generated by the model is widely used in professional environments and daily life, and also brings challenges in the aspect of global information security. These challenges include how to identify whether the content is generated by the model or the content is generated artificially.

### SUMMARY

In a first aspect of the present disclosure, a method of processing information is provided. The method comprises: obtaining target content to be processed; determining a target encoding representation of the target content with an encoding model; and determining a target generation manner of the target content based on a comparison between the target encoding representation and a plurality of predetermined encoding representations, the plurality of predetermined encoding representations corresponding to a plurality of predetermined generation manners, the plurality of predetermined generation manners comprising a plurality of model generation manners, the plurality of predetermined encoding representations being determined by processing a plurality of groups of sample contents with the encoding model, each group of sample contents corresponding to a respective predetermined generation manner.

In a second aspect of the present disclosure, there is provided an apparatus for processing information. The apparatus comprises: an obtaining module, configured to obtain a target content to be processed; an encoding module, configured to determine a target encoding representation of the target content with an encoding model; and a recognition module, configured to determine, based on a comparison between the target encoding representation and a plurality of predetermined encoding representations, a target generation manner of the target content, the plurality of predetermined encoding representations corresponding to a plurality of predetermined generation manners, the plurality of predetermined generation manners comprising a plurality of model generation manners, the plurality of predetermined encoding representations being determined by processing a plurality of groups of sample contents with the encoding model, each group of sample contents corresponding to a respective predetermined generation manner.

In a third aspect of the present disclosure, an electronic device is provided. The device comprises at least one processor; and at least one memory coupled to the at least one processor and storing instructions executable by the at least one processor. The instructions, when executed by the at least one processor, cause the device to perform the method of the first aspect.

In a fourth aspect of the present disclosure, a computer-readable storage medium is provided. The computer-readable storage medium stores a computer program, and the computer program is executable by the processor to implement the method of the first aspect.

It should be understood that the content described in this content section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, wherein:

FIG. 1 shows a schematic diagram of an information processing system according to some embodiments of the present disclosure;

FIG. 2 shows a flowchart of an information processing process according to some embodiments of the present disclosure;

FIG. 3 is a schematic structural block diagram of an apparatus for processing information according to some embodiments of the present disclosure; and

FIG. 4 illustrates a block diagram of an electronic device capable of implementing various embodiments of the present disclosure.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms, and should not be construed as limited to the embodiments set forth herein, but rather, these embodiments are provided for a more thorough and complete understanding of the present disclosure. It should be understood that the drawings and embodiments of the present disclosure are for exemplary purposes only and are not intended to limit the scope of the present disclosure.

It should be noted that the title of any section/subsection provided herein is not limiting. Various embodiments are described throughout and any type of embodiments may be included in any section/subsection. Furthermore, the embodiments described in any section/subsection may be combined in any manner with the same section/subsection and/or any other embodiment described in different sections/subsections.

In the description of the embodiments of the present disclosure, the terms “including” and the like should be understood to include “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below. The terms “first,” “second,” and the like may refer to different or identical objects. Other explicit and implicit definitions may also be included below.

Embodiments of the present disclosure may relate to data of a user, acquisition and/or use of data, and the like. These aspects all follow the corresponding laws and regulations and related regulations. In the embodiments of the present disclosure, all data is collected, obtained, processed, manufactured, forwarded, used, etc., all of which are performed on the premise that the user knows and confirms. Accordingly, when implementing the embodiments of the present disclosure, the types, the usage scope, the usage scenario, and the like of the data or information that may be involved should be notified to the user and obtain the authorization of the user in an appropriate manner according to the relevant laws and regulations. The specific notification and/or authorization manner may vary according to actual situations and application scenarios, and the scope of the present disclosure is not limited in this respect.

According to the solutions in the present specification and the embodiments, for example, personal information processing is involved, processing may be performed on the premise of having a legality basis (for example, obtaining consent of a personal information subject, or necessary for performing a fulfillment of the contract), and processing only within a specified or agreed range. The user rejects personal information other than necessary information required by the basic function, and does not affect the basic function of the user.

As briefly mentioned above, the content generated by the model is widely used in professional environments and daily life, and also brings challenges in the aspect of global information security. Therefore, detecting content generated by the models becomes a crucial task.

The embodiment of the present disclosure provides a scheme for processing information. According to the scheme, the target content to be processed may be obtained. Further, a target encoding representation of the target content may be determined with an encoding model. Correspondingly, the target generation manner of the target content may be determined based on a comparison between the target encoding representation and a plurality of predetermined encoding representations, the plurality of predetermined encoding representations corresponding to a plurality of predetermined generation manners, the plurality of predetermined generation manners comprising a plurality of model generation manners, the plurality of predetermined encoding representations being determined by processing a plurality of groups of sample contents with the encoding model, each group of sample contents corresponding to a respective predetermined generation manner.

In this way, implementations of the present disclosure can more accurately identify the generation manner of the content by means of feature query, for example, determining whether content is generated using a model, and what model is used for generation.

Various example implementations of this scheme are described in detail below in conjunction with the accompanying drawings.

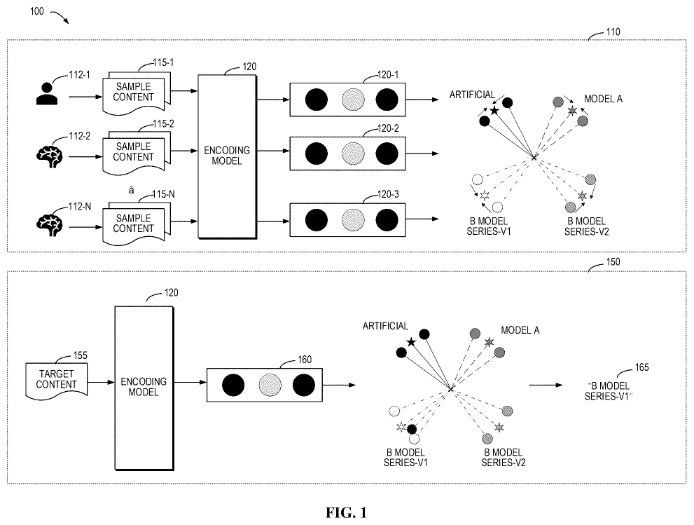

FIG. 1 illustrates a schematic diagram of an example information processing system 100 in which embodiments of the present disclosure can be implemented. As shown in FIG. 1, the processing flow of the information processing system 100 may comprise a training phase 110 and an inference phase 150.

As shown in FIG. 1, in the training phase 110, the information processing system 100 may train the encoding model 120 to generate a plurality of predetermined encoding representations corresponding to the plurality of predetermined generation manners.

As an example, such a plurality of predetermined generation manners may include an artificial generation manner 112-1 and one or more model generation manners 112-2 to 112-N. In some embodiments, such model generation manner may correspond to different model entities to enable the information processing system 100 to identify that the content is generated artificially or the content is generated by what type of specific model entity.

In some embodiments, in the training phase 110, the information processing system 100 may process, with the encoding model 120, a plurality of groups of sample contents corresponding to a plurality of predetermined generation manners, for example, a group of sample contents 115-1, a group of sample contents 115-2, . . . , a group of sample contents 115-N.

In some embodiments, such sample content may include any suitable type of content, such as text content, image content, audio content, video content, and the like.

Taking a group of sample contents 115-1 as an example, the information processing system 100 may utilize the encoding model 120 to determine a corresponding group of sample encoding representations 120-1. Further, the information processing system 110 may determine a predetermined encoding representation corresponding to the generation manner (for example, the artificial generation manner 112-1) based on the group of sample encoding representations 120-1.

As an example, the information processing system 110 may determine a plurality of sample encoding representations of a plurality of artificially generated sample contents, and may determine an encoding representation corresponding to the artificial generation manner by determining a cluster center of the plurality of sample encoding representations.

In some embodiments, for the plurality of groups of sample contents 115-1 to 115-N, the information processing system 100 may determine a corresponding plurality of sample encoding representations, and may train the encoding model 120 based on similarities between different sample encoding representations.

In some embodiments, the information processing system 100 may train the encoding model 120 such that a similarity between encoding representations of an artificially generated sample content is greater than a similarity between the artificially generated sample and the encoding representation of the model generated sample.

As an example, for the i th sample content Tᵢ, the information processing system 120 may assign label xᵢ. If the sample content Tᵢ is artificially generated, then xᵢ=1. In contrast, if the sample content Tᵢ is model generated, then xᵢ=0. Thus, the training objective may be expressed as:

$$\begin{matrix}S ( i , j ) > S ( i , k ) , & ∀ {x}_{i} = 1 , & {x}_{i} = {x}_{j} , & {x}_{i} \neq {x}_{k}\end{matrix} \qquad ( 1 )$$

Where S (i, j) represents a first similarity between the first pair of sample encoding representations, the first pair of sample encoding representations includes a sample encoding representation of the i th sample content Tᵢ and a sample encoding representation of the j th sample content Tⱼ, wherein the sample content T; and the sample content Tⱼ are both artificially generated samples (i.e., corresponding to an artificial generation manner); S (i, k) represents a second similarity between the second pair of sample encoding representations, the second pair of sample encoding representations includes a sample encoding representation (i.e., the first sample encoding representation) of the i th sample content Tᵢ and a sample encoding representation (i.e., the second sample encoding representation) of the k th sample content Tₖ, wherein the sample content Tᵢ is an artificially generated sample, and the sample content Tₖ is a sample generated by the model (i.e., corresponding to the model generation manner).

In some embodiments, the information processing system 100 may train the encoding model 120 such that similarities between encoding representations of sample contents corresponding to the same model series are greater than similarities between encoding representations of sample contents corresponding to different model series.

As an example, for the i th sample content Tᵢ, if the sample content is generated by the model, the information processing system 120 may assign labels yᵢ and zᵢ, where yᵢ is used to identify the model series corresponding to the sample content, and zᵢ is used to identify the specific model entity corresponding to the sample. As an example, the model series may be determined based on a publisher of the generation model. For example, a plurality of models published by the same publisher may be determined to be the same model series. As another example, different versions of a model published by the same publisher may correspond to different model entities in the model series. As an example, the training objective may be expressed as:

$$\begin{matrix}S ( i , j ) > S ( i , k ) , & ∀ {x}_{i} = 0 , & {z}_{i} \neq {z}_{j} , & {y}_{i} = {y}_{j} , & {y}_{i} \neq {y}_{k}\end{matrix} \qquad ( 2 )$$

Where S (i, j) represents a third similarity between the third pair of sample encoding representations, the third pair of sample encoding representations includes a sample encoding representation of the i th sample content Tᵢ and a sample encoding representation of the j th sample content Tⱼ, wherein the sample content Tᵢ and the sample content Tⱼ are sample contents corresponding to different model entities in the same model series (i.e., corresponding to different model generation manners in the first model series); S (i, k) represents a fourth similarity between the fourth pair of sample encoding representations, the fourth pair of sample encoding representations includes a sample encoding representation (i.e., a third sample encoding representation) of the i th sample content Tᵢ and a sample encoding representation (i.e., a fourth sample encoding representation) of the k th sample content Tₖ, wherein the sample content Tᵢ and the sample content Tₖ correspond to different model series (e.g., Tᵢ corresponds to a specific model generation manner in the first model series, and Tₖ corresponds to a specific model generation manner in the second model series).

In some embodiments, the information processing system 100 may train the encoding model 120 such that similarities between encoding representations of sample contents corresponding to model entities in different model series are greater than similarities between encoding representations of sample contents generated by the model entity and encoding representations of artificially generated sample contents.

As an example, the training objective may be expressed as:

$$\begin{matrix}S ( i , j ) > S ( i , k \vert ) , & ∀ {x}_{i} = 0 , & {y}_{i} \neq {y}_{j} , & {x}_{i} = {x}_{j} , & {x}_{i} \neq {x}_{k}\end{matrix} \qquad ( 3 )$$

Where S (i, j) represents a fifth similarity between the fifth pair of sample encoding representations, the fifth pair of sample encoding representations includes a sample encoding representation (i.e., a fifth sample encoding representation) of the i th sample content Tᵢ and a sample encoding representation (i.e., a sixth sample encoding representation) of the j th sample content Tⱼ, wherein the sample content Tᵢ is generated by the first model entity (i.e., corresponding to the first model generation manner), the sample content Tⱼ is generated by the second model entity (i.e., corresponding to the second model generation manner), the first model entity and the second model entity correspond to different model series; S (i, k) represents a sixth similarity between the sixth pair of sample encoding representations, the sixth pair of sample encoding representations includes a sample encoding representation (i.e., a fifth sample encoding representation) of the i th sample content Tᵢ and a sample encoding representation (i.e., a seventh sample encoding representation) of the k th sample content Tₖ, wherein the sample content Tₖ is the artificially generated sample (i.e., corresponding to an artificial generation manner).

In some embodiments, the information processing system 100 may train the encoding model 120 such that a similarity between encoding representations of sample contents corresponding to the same model entity is greater than a similarity between encoding representations of sample contents corresponding to any of the different model entities.

As an example, the training objective may be expressed as:

$$\begin{matrix}S ( i , j ) > S ( i , k ) , & ∀ {x}_{i} = 0 , & {z}_{i} = {z}_{j} , & {z}_{i} \neq {z}_{k}\end{matrix} \qquad ( 4 )$$

Where S (i, j) represents a seventh similarity between the seventh pair of sample encoding representations, the seventh pair of sample encoding representations includes a sample encoding representation of the i th sample content Tᵢ and a sample encoding representation of the j th sample content Tⱼ, where the sample content T; and the sample content Tⱼ are generated by the same model entity (e.g., corresponding to the third model generation manner); S (i, k) represents an eighth similarity between the eighth pair of sample encoding representations, the eighth pair of sample encoding representations includes a sample encoding representation (i.e., an eighth sample encoding representation) of the i th sample content Tᵢ and a sample encoding representation (i.e., a ninth sample encoding representation) of the k th sample content Tₖ, where the sample content Tₖ is a sample generated by another model generation entity (i.e., corresponding to the fourth model generation manner).

Further, the loss function of the encoding model 120 may be expressed as:

$${ℒ}_{q} = - log \frac{exp ( {\sum }_{k ∈ {K}^{+}} \frac{S ( q , k )}{τ} / {N}_{{K}^{+}} )}{exp ( {\sum }_{k ∈ {K}^{+}} \frac{S ( q , k )}{τ} / {N}_{{K}^{+}} ) + {\sum }_{k ∈ {K}^{-}} exp ( \frac{S ( q , k )}{τ} )} . \qquad ( 5 )$$

$${ℒ}_{mcl} = {\sum }_{i = 1}^{N} {x}_{i} \cdot ( δ \cdot {ℒ}_{{q}_{i} , 1} ) + ( 1 - {x}_{i} ) \cdot ( α \cdot {ℒ}_{{q}_{i} , 2} + β \cdot {ℒ}_{{q}_{i} , 3} + γ \cdot {ℒ}_{{q}_{i} , 4} ) . \qquad ( 6 )$$

The formula (5) is the loss function of the contrast learning, Where K⁺ represents a positive sample set, K-represents a negative sample set, T represents a temperature coefficient, N_{K+} represents a sample number of the positive sample set, and formula (6) is a loss function of the encoding model 120, and 8, a, B, and y are weight coefficients corresponding to different levels.

Through the hierarchical design, the loss function effectively captures fine differences among different contents, and enhances the recognition capability of content features of different sources.

In some embodiments, the information processing system 100 may further utilize a classification model to cooperatively train the encoding model 120. Specifically, the information processing system 100 may utilize the encoding model 120 to determine an intermediate encoding representation of the target sample content. Further, the information processing system 100 may process the intermediate encoding representation with a classification model to generate classification information of the target sample content, where the classification information indicates whether the target sample content is classified as the artificial generation manner.

Correspondingly, the information processing system 100 may train the encoding model 120 based on the comparison between the classification information and the annotation information of the target sample content, where the annotation information indicates whether the target sample content corresponds to the artificial generation manner.

As an example, the loss may be expressed as:

$${ℒ}_{ce} = - \frac{1}{N} {\sum }_{i = 1}^{N} {x}_{i} \cdot log ( {p}_{i} ) + ( 1 - {x}_{i} ) \cdot log ( 1 - {p}_{i} ) \qquad ( 7 )$$

Where pᵢ represents the probability that the i th sample content Tᵢ is classified as an artificial generation manner.

Thus, the total loss function of the encoding model 120 may be expressed as:

$${ℒ}_{all} = {ℒ}_{mcl} + {ℒ}_{ce} \qquad ( 8 )$$

In this manner, the information processing system 100 may train the encoding model 120 to enable it to generate a sample encoding representation of sample content corresponding to different generation manners. Further, the information processing system 100 may determine, as an encoding representation set, a predetermined encoding representation corresponding to each predetermined generation manner by determining a cluster center of the sample encoding representation.

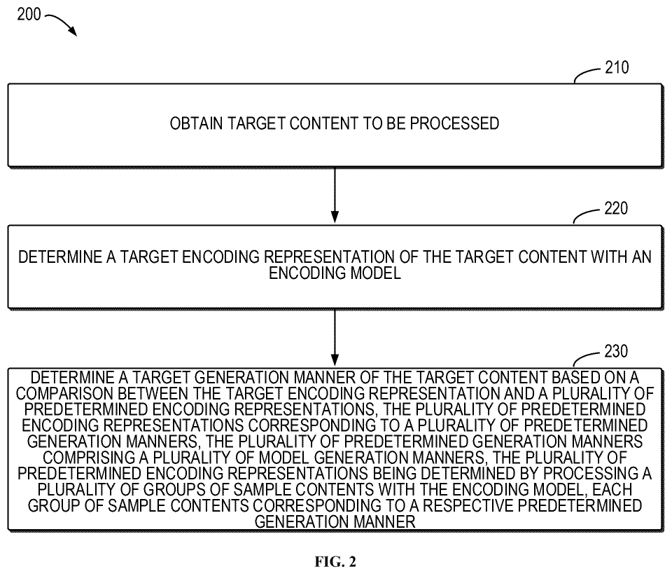

The information processing system 100 is further described below with reference to FIG. 2 to perform the specific process of the recognition of the generation manner with the trained encoding model 120. FIG. 2 shows a flowchart of an example information processing process 200 according to some embodiments of the present disclosure. Process 200 may be implemented, for example, at an information processing system 100 as shown in FIG. 1. Process 200 will be described below with reference to FIG. 1.

As shown in FIG. 2, at block 210, the information processing system 100 obtains target content to be processed.

As shown in FIG. 1, in an inference phase 150, the information processing system 100 may obtain target content 155 to be processed. As introduced above, such target content 155 may include any suitable type of content, such as text content, image content, audio content, video content, and the like.

With continued reference to FIG. 2, at block 220, the information processing system 100 determines a target encoding representation of the target content with the encoding model 120.

As shown in FIG. 1, the information processing system 100 may determine a target encoding representation 160 of the target content 155 with the encoding model 120.

At block 230, the information processing system 100 determines a target generation manner of the target content based on a comparison between the target encoding representation and a plurality of predetermined encoding representations. As described with reference to FIG. 1, the plurality of predetermined encoding representations corresponds to a plurality of predetermined generation manners, the plurality of predetermined generation manners comprises a plurality of model generation manners, the plurality of predetermined encoding representations is determined by processing a plurality of groups of sample contents with the encoding model, each group of sample contents corresponding to a respective predetermined generation manner.

In some embodiments, the information processing system 100 may determine a similarity between the target encoding representation 160 and the plurality of predetermined encoding representations. As an example, the information processing system 100 may determine a target predetermined encoding representation whose similarity is greater than a threshold, and may determine a predetermined generation manner corresponding to the target predetermined encoding representation as the target generation manner 165 of the target content 155.

In some embodiments, if the similarity between the target encoding representation 160 and the plurality of predetermined encoding representations is lower than a threshold, the information processing system 100 may consider that the target content is in a scenario of out of distribution (OOD). In some embodiments, in order to improve the processing capability of the OOD scenario, the information processing system 100 may further add the target encoding representation 160 corresponding to the ODD scenario to the plurality of predetermined encoding representations for subsequent inference processes. Such OOD scenarios may include new model-generated content or new domain content.

Therefore, the embodiments of the present disclosure can directly encode the OOD data with a pre-trained encoder, and integrate the encoded features into an existing encoding representation set, thereby improving adaptability to OOD data without additional training.

Based on the process described above, implementations of the present disclosure can more accurately identify the generation manner of the content in a feature query manner, for example, determine whether the content is generated using a model, and what model is used for the generation.

### Example Apparatus and Device

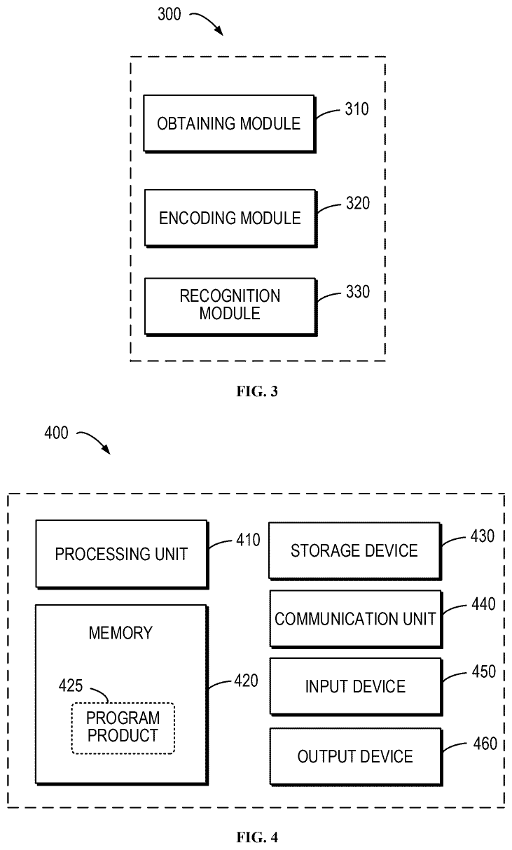

Embodiments of the present disclosure also provide a corresponding apparatus for implementing the above method or process. FIG. 3 is a schematic structural block diagram of an apparatus 300 for processing information according to some embodiments of the present disclosure. The apparatus 300 may be implemented or included in an electronic device. The various modules/components in the apparatus 300 may be implemented by hardware, software, firmware, or any combination thereof.

As shown in FIG. 3, the apparatus 300 includes an obtaining module 310, configured to obtain a target content to be processed; an encoding module 320, configured to determine a target encoding representation of the target content with an encoding model; and a recognition module 330, configured to determine, based on a comparison between the target encoding representation and a plurality of predetermined encoding representations, a target generation manner of the target content, the plurality of predetermined encoding representations corresponding to a plurality of predetermined generation manners, the plurality of predetermined generation manners comprising a plurality of model generation manners, the plurality of predetermined encoding representations being determined by processing a plurality of groups of sample contents with the encoding model, each group of sample contents corresponding to a respective predetermined generation manner.

In some embodiments, the plurality of predetermined generation manners comprise a first predetermined generation manner and a first predetermined encoding representation corresponding to the first predetermined generation manner is determined based on the following process: processing a group of sample contents corresponding to the first predetermined generation manner with the encoding model, to determine a group of sample encoding representations; and determining the first predetermined encoding representation corresponding to the first predetermined generation manner based on the group of sample encoding representations.

In some embodiments, the encoding model is trained based on the following process: determining a plurality of sample encoding representations based on the plurality of groups of sample contents; and training the encoding model based on respective similarities between different sample encoding representations.

In some embodiments, the plurality of predetermined generation manners further comprise a artificial generation manner, and training the encoding model based on the respective similarities between different sample encoding representations comprises: determining a first similarity between a first pair of sample encoding representations, the first pair of sample encoding representations corresponding to the artificial generation manner; determining a second similarity between a second pair of sample encoding representations, the second pair of sample encoding representations comprising a first sample encoding representation corresponding to the artificial generation manner and a second sample encoding representation corresponding to any model generation manner; and adjusting the encoding model such that the first similarity is greater than the second similarity.

In some embodiments, the plurality of model generation manners comprise a first group of generation manners corresponding to a first model series and a second group of generation manners corresponding to a second model series, and training the encoding model based on the respective similarities between different sample encoding representations comprises: determining a third similarity between a third pair of sample encoding representations, the third pair of sample encoding representations corresponding to the first group of generation manners; determining a fourth similarity between a fourth pair of sample encoding representations, the fourth pair of sample encoding representations comprising a third sample encoding representation corresponding to the first group of generation manners and a fourth sample encoding representation corresponding to the second group of generation manners; and adjusting the encoding model such that the third similarity is greater than the fourth similarity.

In some embodiments, the plurality of predetermined generation manners comprise an artificial generation manner, and training the encoding model based on the respective similarities between different sample encoding representations comprises: determining a fifth similarity between a fifth pair of sample encoding representations, the fifth pair of sample encoding representations corresponding to a fifth sample encoding representation corresponding to a first model generation manner and a sixth sample encoding representation corresponding to a second model generation manner, the first model generation manner and the second model generation manner corresponding to different model series; determining a sixth similarity between a sixth pair of sample encoding representations, the sixth pair of sample encoding representations comprising the fifth sample encoding representation corresponding to the first model generation manner and a seventh sample encoding representation corresponding to the artificial generation manner; and adjusting the encoding model such that the fifth similarity is greater than the sixth similarity.

In some embodiments, the plurality of predetermined generation manners comprise a third model generation manner and a fourth model generation manner, and training the encoding model based on the respective similarities between different sample encoding representations comprises: determining a seventh similarity between a seventh pair of sample encoding representations, the seventh pair of sample encoding representations corresponding to the third model generation manner; determining an eighth similarity between an eighth pair of sample encoding representations, the eighth pair of sample encoding representations comprising an eighth sample encoding representation corresponding to the third model generation manner and a ninth sample encoding representation corresponding to the fourth model generation manner; and adjusting the encoding model such that the seventh similarity is greater than the eighth similarity.

In some embodiments, the plurality of predetermined generation manners comprise an artificial generation manner, and training the encoding model based on the respective similarities between different sample encoding representations further comprises: determining an intermediate encoding representation of a target sample content with the encoding model; processing the intermediate encoding representation with a classification model to generate classification information of the target sample content, the classification information indicating whether the target sample content is classified as the artificial generation manner; and training the encoding model based on a comparison between the classification information and annotation information of the target sample content, the annotation information indicating whether the target sample content corresponds to the artificial generation manner.

In some embodiments, the apparatus 300 further comprises an updating module, configured to: in response to a plurality of similarities between the target encoding representation and a plurality of predetermined encoding representations all being lower than a threshold, adding the target encoding representation to the plurality of predetermined encoding representations.

In some embodiments, the target content comprises text content.

FIG. 4 illustrates a block diagram of an electronic device 400 in which one or more embodiments of the present disclosure may be implemented. It should be understood that the electronic device 400 illustrated in FIG. 4 is merely exemplary and should not constitute any limitation on the functionality and scope of the embodiments described herein. The electronic device 400 shown in FIG. 4 may be used for the information processing system 100 shown in FIG. 1.

As shown in FIG. 4, the electronic device 400 is in the form of a general-purpose electronic device. Components of the electronic device 400 may include, but are not limited to, one or more processors or processing units 410, a memory 420, a storage device 430, one or more communication units 440, one or more input devices 450, and one or more output devices 460. The processing unit 410 may be an actual or virtual processor and capable of performing various processes according to programs stored in the memory 420. In multiprocessor systems, multiple processing units execute computer-executable instructions in parallel to improve parallel processing capabilities of electronic device 400.

Electronic device 400 typically includes a plurality of computer storage media. Such media may be any available media accessible to the electronic device 400, including, but not limited to, volatile and non-volatile media, removable and non-removable media. The memory 420 may be volatile memory (e.g., registers, caches, random access memory (RAM)), non-volatile memory (e.g., read-only memory (ROM), electrically erasable programmable read-only memory (EEPROM), flash memory), or some combination thereof. Storage device 430 may be a removable or non-removable medium and may include a machine-readable medium, such as a flash drive, a magnetic disk, or any other medium that can be used to store information and/or data and that can be accessed within electronic device 400.

The electronic device 400 may further include additional removable/non-removable, volatile/non-volatile storage media. Although not shown in FIG. 4, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interfaces. The memory 420 may include a computer program product 425 having one or more program modules configured to perform various methods or actions of various embodiments of the present disclosure.

The communication unit 440 is configured to communicate with another electronic device through a communication medium. Additionally, the functionality of components of the electronic device 400 may be implemented in a single computing cluster or multiple computing machines capable of communicating over a communication connection. Thus, the electronic device 400 may operate in a networked environment using logical connections with one or more other servers, network personal computers (PCs), or another network node.

The input device 450 may be one or more input devices such as a mouse, a keyboard, a trackball, or the like. The output device 460 may be one or more output devices, such as a display, a speaker, a printer, or the like. The electronic device 400 may also communicate with one or more external devices (not shown) through the communication unit 440 as needed, external devices such as storage devices, display devices, etc., communicate with one or more devices that enable a user to interact with the electronic device 400, or communicate with any device (e.g., a network card, a modem, etc.) that enables the electronic device 400 to communicate with one or more other electronic devices. Such communication may be performed via an input/output (I/O) interface (not shown).

According to example implementations of the present disclosure, there is provided a computer-readable storage medium having computer-executable instructions stored thereon, wherein the computer-executable instructions are executed by a processor to implement the method described above. According to example implementations of the present disclosure, a computer program product is further provided, the computer program product being tangibly stored on a non-transitory computer-readable medium and including computer-executable instructions, the computer-executable instructions being executed by a processor to implement the method described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce means to implement the functions/acts specified in the flowchart and/or block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowchart and/or block diagram(s).

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on a computer, other programmable data processing apparatus, or other apparatus implement the functions/acts specified in the flowchart and/or block diagram block or blocks.

The flowchart and block diagrams in the figures show architecture, functionality, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are exemplary, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

What is claimed is:

1. A method of processing information, comprising:
obtaining target content to be processed;
determining a target encoding representation of the target content with an encoding model; and
determining a target generation manner of the target content based on a comparison between the target encoding representation and a plurality of predetermined encoding representations, the plurality of predetermined encoding representations corresponding to a plurality of predetermined generation manners, the plurality of predetermined generation manners comprising a plurality of model generation manners, the plurality of predetermined encoding representations being determined by processing a plurality of groups of sample contents with the encoding model, each group of sample contents corresponding to a respective predetermined generation manner.

2. The method of claim 1, wherein the plurality of predetermined generation manners comprise a first predetermined generation manner and a first predetermined encoding representation corresponding to the first predetermined generation manner is determined based on the following process:
processing a group of sample contents corresponding to the first predetermined generation manner with the encoding model, to determine a group of sample encoding representations; and
determining the first predetermined encoding representation corresponding to the first predetermined generation manner based on the group of sample encoding representations.

3. The method of claim 1, wherein the encoding model is trained based on the following process:
determining a plurality of sample encoding representations based on the plurality of groups of sample contents; and
training the encoding model based on respective similarities between different sample encoding representations.

4. The method of claim 3, wherein the plurality of predetermined generation manners further comprise a artificial generation manner, and training the encoding model based on the respective similarities between different sample encoding representations comprises:
determining a first similarity between a first pair of sample encoding representations, the first pair of sample encoding representations corresponding to the artificial generation manner;
determining a second similarity between a second pair of sample encoding representations, the second pair of sample encoding representations comprising a first sample encoding representation corresponding to the artificial generation manner and a second sample encoding representation corresponding to any model generation manner; and
adjusting the encoding model such that the first similarity is greater than the second similarity.

5. The method of claim 3, wherein the plurality of model generation manners comprise a first group of generation manners corresponding to a first model series and a second group of generation manners corresponding to a second model series, and training the encoding model based on the respective similarities between different sample encoding representations comprises:
determining a third similarity between a third pair of sample encoding representations, the third pair of sample encoding representations corresponding to the first group of generation manners;
determining a fourth similarity between a fourth pair of sample encoding representations, the fourth pair of sample encoding representations comprising a third sample encoding representation corresponding to the first group of generation manners and a fourth sample encoding representation corresponding to the second group of generation manners; and
adjusting the encoding model such that the third similarity is greater than the fourth similarity.

6. The method of claim 3, wherein the plurality of predetermined generation manners comprise an artificial generation manner, and training the encoding model based on the respective similarities between different sample encoding representations comprises:
determining a fifth similarity between a fifth pair of sample encoding representations, the fifth pair of sample encoding representations corresponding to a fifth sample encoding representation corresponding to a first model generation manner and a sixth sample encoding representation corresponding to a second model generation manner, the first model generation manner and the second model generation manner corresponding to different model series;
determining a sixth similarity between a sixth pair of sample encoding representations, the sixth pair of sample encoding representations comprising the fifth sample encoding representation corresponding to the first model generation manner and a seventh sample encoding representation corresponding to the artificial generation manner; and
adjusting the encoding model such that the fifth similarity is greater than the sixth similarity.

7. The method of claim 3, wherein the plurality of predetermined generation manners comprise a third model generation manner and a fourth model generation manner, and training the encoding model based on the respective similarities between different sample encoding representations comprises:
determining a seventh similarity between a seventh pair of sample encoding representations, the seventh pair of sample encoding representations corresponding to the third model generation manner;
determining an eighth similarity between an eighth pair of sample encoding representations, the eighth pair of sample encoding representations comprising an eighth sample encoding representation corresponding to the third model generation manner and a ninth sample encoding representation corresponding to the fourth model generation manner; and
adjusting the encoding model such that the seventh similarity is greater than the eighth similarity.

8. The method of claim 3, wherein the plurality of predetermined generation manners comprise an artificial generation manner, and training the encoding model based on the respective similarities between different sample encoding representations further comprises:
determining an intermediate encoding representation of a target sample content with the encoding model;
processing the intermediate encoding representation with a classification model to generate classification information of the target sample content, the classification information indicating whether the target sample content is classified as the artificial generation manner; and
training the encoding model based on a comparison between the classification information and annotation information of the target sample content, the annotation information indicating whether the target sample content corresponds to the artificial generation manner.

9. The method of claim 1, further comprising:
in response to a plurality of similarities between the target encoding representation and a plurality of predetermined encoding representations all being lower than a threshold, adding the target encoding representation to the plurality of predetermined encoding representations.

10. The method of claim 1, wherein the target content comprises text content.

11. An electronic device, comprising:
at least one processor; and
at least one memory coupled to the at least one processor and storing instructions executable by the at least one processor, the instructions, upon execution by the at least one processor, causing the electronic device to perform a method of processing information, comprising:
obtaining target content to be processed;
determining a target encoding representation of the target content with an encoding model; and
determining a target generation manner of the target content based on a comparison between the target encoding representation and a plurality of predetermined encoding representations, the plurality of predetermined encoding representations corresponding to a plurality of predetermined generation manners, the plurality of predetermined generation manners comprising a plurality of model generation manners, the plurality of predetermined encoding representations being determined by processing a plurality of groups of sample contents with the encoding model, each group of sample contents corresponding to a respective predetermined generation manner.

12. The electronic device of claim 11, wherein the plurality of predetermined generation manners comprise a first predetermined generation manner and a first predetermined encoding representation corresponding to the first predetermined generation manner is determined based on the following process:
processing a group of sample contents corresponding to the first predetermined generation manner with the encoding model, to determine a group of sample encoding representations; and
determining the first predetermined encoding representation corresponding to the first predetermined generation manner based on the group of sample encoding representations.

13. The electronic device of claim 11, wherein the encoding model is trained based on the following process:
determining a plurality of sample encoding representations based on the plurality of groups of sample contents; and
training the encoding model based on respective similarities between different sample encoding representations.

14. The electronic device of claim 13, wherein the plurality of predetermined generation manners further comprise a artificial generation manner, and training the encoding model based on the respective similarities between different sample encoding representations comprises:
determining a first similarity between a first pair of sample encoding representations, the first pair of sample encoding representations corresponding to the artificial generation manner;
determining a second similarity between a second pair of sample encoding representations, the second pair of sample encoding representations comprising a first sample encoding representation corresponding to the artificial generation manner and a second sample encoding representation corresponding to any model generation manner; and
adjusting the encoding model such that the first similarity is greater than the second similarity.

15. The electronic device of claim 13, wherein the plurality of model generation manners comprise a first group of generation manners corresponding to a first model series and a second group of generation manners corresponding to a second model series, and training the encoding model based on the respective similarities between different sample encoding representations comprises:
determining a third similarity between a third pair of sample encoding representations, the third pair of sample encoding representations corresponding to the first group of generation manners;
determining a fourth similarity between a fourth pair of sample encoding representations, the fourth pair of sample encoding representations comprising a third sample encoding representation corresponding to the first group of generation manners and a fourth sample encoding representation corresponding to the second group of generation manners; and
adjusting the encoding model such that the third similarity is greater than the fourth similarity.

16. The electronic device of claim 13, wherein the plurality of predetermined generation manners comprise an artificial generation manner, and training the encoding model based on the respective similarities between different sample encoding representations comprises:
determining a fifth similarity between a fifth pair of sample encoding representations, the fifth pair of sample encoding representations corresponding to a fifth sample encoding representation corresponding to a first model generation manner and a sixth sample encoding representation corresponding to a second model generation manner, the first model generation manner and the second model generation manner corresponding to different model series;
determining a sixth similarity between a sixth pair of sample encoding representations, the sixth pair of sample encoding representations comprising the fifth sample encoding representation corresponding to the first model generation manner and a seventh sample encoding representation corresponding to the artificial generation manner; and
adjusting the encoding model such that the fifth similarity is greater than the sixth similarity.

17. The electronic device of claim 13, wherein the plurality of predetermined generation manners comprise a third model generation manner and a fourth model generation manner, and training the encoding model based on the respective similarities between different sample encoding representations comprises:
determining a seventh similarity between a seventh pair of sample encoding representations, the seventh pair of sample encoding representations corresponding to the third model generation manner;
determining an eighth similarity between an eighth pair of sample encoding representations, the eighth pair of sample encoding representations comprising an eighth sample encoding representation corresponding to the third model generation manner and a ninth sample encoding representation corresponding to the fourth model generation manner; and
adjusting the encoding model such that the seventh similarity is greater than the eighth similarity.

18. The electronic device of claim 13, wherein the plurality of predetermined generation manners comprise an artificial generation manner, and training the encoding model based on the respective similarities between different sample encoding representations further comprises:
determining an intermediate encoding representation of a target sample content with the encoding model;
processing the intermediate encoding representation with a classification model to generate classification information of the target sample content, the classification information indicating whether the target sample content is classified as the artificial generation manner; and
training the encoding model based on a comparison between the classification information and annotation information of the target sample content, the annotation information indicating whether the target sample content corresponds to the artificial generation manner.

19. The electronic device of claim 11, the method further comprises:
in response to a plurality of similarities between the target encoding representation and a plurality of predetermined encoding representations all being lower than a threshold, adding the target encoding representation to the plurality of predetermined encoding representations.

20. A non-transitory computer-readable storage medium, storing computer program thereon, the computer program, when executed by a processor cause the processor to implement a method of processing information, comprising:
obtaining target content to be processed;
determining a target encoding representation of the target content with an encoding model; and
determining a target generation manner of the target content based on a comparison between the target encoding representation and a plurality of predetermined encoding representations, the plurality of predetermined encoding representations corresponding to a plurality of predetermined generation manners, the plurality of predetermined generation manners comprising a plurality of model generation manners, the plurality of predetermined encoding representations being determined by processing a plurality of groups of sample contents with the encoding model, each group of sample contents corresponding to a respective predetermined generation manner.
